(19) United States
(12) Patent Application Publication
(10) Pub. No.: US 2025/0298302 A1
(43) Pub. Date: Sep. 25, 2025

(54) BEAM PROJECTION APPARATUS AND PROJECTOR THEREOF

(71) Applicant: QISDA CORPORATION, Taoyuan City (TW)

(72) Inventors: Chih-Shiung Chien, Taoyuan City (TW); Ming-Kuen Lin, Taoyuan City (TW); Yu-Cheng Chen, Taipei City (TW)

(73) Assignee: QISDA CORPORATION, Taoyuan City (TW)

(21) Appl. No.: 19/075,742

(22) Filed: Mar. 10, 2025

(30) Foreign Application Priority Data
Mar. 22, 2024 (CN) 202410336687.X

(51) Int. Cl. G03B 21/20; G03B 21/00

(52) U.S. Cl. CPC G03B 21/2066; G03B 21/008

(57) ABSTRACT

Abeam projection apparatus includes a light source, a condensing lens, a wavelength-conversion component, a reflective-transmissive component, a micromirror component, a light-guide lens set and a projection lens. The wavelength-conversion component at least partially converts a wavelength of a color light transmitted from the condensing lens and reflects the color light to the condensing lens. The reflective-transmissive component is partially overlapped with the condensing lens and has a dichroic region and a reflective region. The dichroic region allows the color light to pass therethrough to be incident to the condensing lens. The reflective region reflects the color light reflected from the wavelength-conversion component back to the reflective-transmissive component, to make the color light incident to the wavelength-conversion component again through the condensing lens. The light-guide lens set guides the color light to the micromirror component to form a projection beam incident to the projection lens for optical projection.

### BACKGROUND OF THE INVENTION

### 1. Field of the Invention

The present invention relates to a beam projection apparatus and a projector thereof, and more specifically, to a beam projection apparatus disposing a reflective-transmissive component having a dichroic region and a reflective region to be partially overlapped with a condensing lens and a projector thereof.

### 2. Description of the Prior Art

In general, as shown in FIG. 1, a beam projection apparatus 1 applied to a projector or vehicle illumination usually utilizes a blue laser source to provide a color light. The color light must pass through a condensing lens 2 and a wavelength-conversion component 3 (e.g., a color wheel partially coated with a phosphor layer) to be converted into another excited color light, and then the another excited color light and the original color light pass through a light guide lens set 4, a digital micromirror device (DMD) 5, and a projection lens 6 to produce a multicolor laser beam required for subsequent image projection.

In the aforesaid configuration, since stray reflections of the color light occur when the color light is incident into internal optical components of the beam projection apparatus, unexpected and unnecessary light leakage paths P (as shown in FIG. 1) often appear inside the beam projection apparatus to cause a light leakage problem, so as to significantly affect the image projection or lighting quality of the beam projection apparatus. In the prior art, the above light leakage problem could be solved by blocking the leakage paths P (e.g., placing a light blocking sheet at a bottom position in front of the projection lens 6 as shown in FIG. 1). However, this light blocking design also causes a reduction in the overall brightness of the beam projection apparatus.

### SUMMARY OF THE INVENTION

The present invention provides a beam projection apparatus including at least one light source, at least one condensing lens, a wavelength-conversion component, a reflective-transmissive component, a micromirror component, a light-guide lens set, and at least one projection lens. The at least one light source emits a color light. The at least one condensing lens has a first lens portion and a second lens portion. The wavelength-conversion component is disposed on a side of the at least one condensing lens for at least partially converting a wavelength of the color light transmitted from the first lens portion and reflecting the color light to the at least one condensing lens, to make the color light travel along a light-exit axis of the second lens portion. The reflective-transmissive component is partially overlapped with the first lens portion and has a dichroic region and a reflective region. The dichroic region allows the color light to pass therethrough to be incident to the first lens portion, and the reflective region is located on at least side of the dichroic region to reflect the color light reflected from the wavelength-conversion component, for making the color light pass through the first lens portion again to be incident to the wavelength-conversion component. The micromirror component is disposed on another side of the at least one condensing lens relative to the wavelength-conversion component. The light-guide lens set is disposed on the light-exit axis to guide the color light to be incident to the micromirror component for forming a projection beam. The at least one projection lens receives the projection beam for optical projection.

The present invention further provides a projector including at least one light source, at least one condensing lens, a wavelength-conversion component, a reflective-transmissive component, a micromirror component, a light-guide lens set, and at least one projection lens. The at least one light source emits a color light. The at least one condensing lens has a first lens portion and a second lens portion. The wavelength-conversion component is disposed on a side of the at least one condensing lens for at least partially converting a wavelength of the color light transmitted from the first lens portion and reflecting the color light to the at least one condensing lens, to make the color light travel along a light-exit axis of the second lens portion. The reflective-transmissive component is partially overlapped with the first lens portion and has a dichroic region and a reflective region. The dichroic region allows the color light to pass therethrough to be incident to the first lens portion, and the reflective region is located on at least side of the dichroic region to reflect the color light reflected from the wavelength-conversion component, for making the color light pass through the first lens portion again to be incident to the wavelength-conversion component. The micromirror component is disposed on another side of the at least one condensing lens relative to the wavelength-conversion component. The light-guide lens set is disposed on the light-exit axis to guide the color light to be incident to the micromirror component for forming a projection beam. The at least one projection lens receives the projection beam for optical projection.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a side view of a beam projection apparatus according to the prior art.

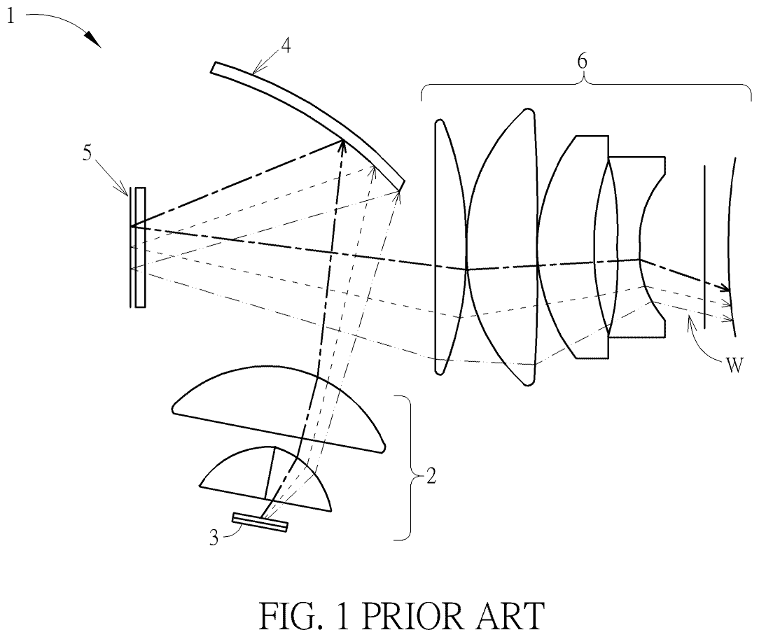

FIG. 2 is a side view of a beam projection apparatus according to an embodiment of the present invention.

FIG. 3 is a top view of a condensing lens in FIG. 2.

FIG. 4 is a side view of a beam projection apparatus according to another embodiment of the present invention.

FIG. 5 is a side view of a beam projection apparatus according to another embodiment of the present invention.

FIG. 6 is a side view of a beam projection apparatus according to another embodiment of the present invention.

FIG. 7 is an enlarged diagram of a color wheel of a wavelength-conversion component in FIG. 6.

### DETAILED DESCRIPTION

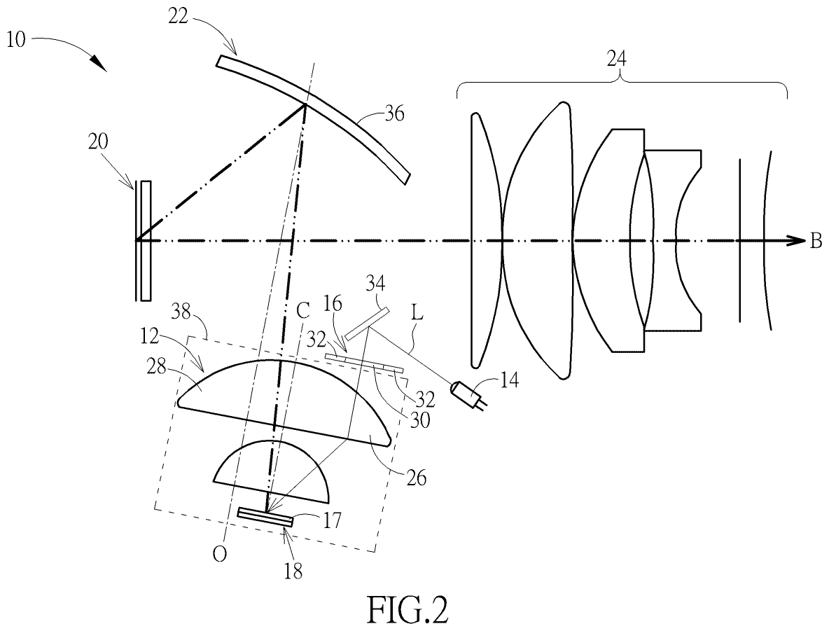

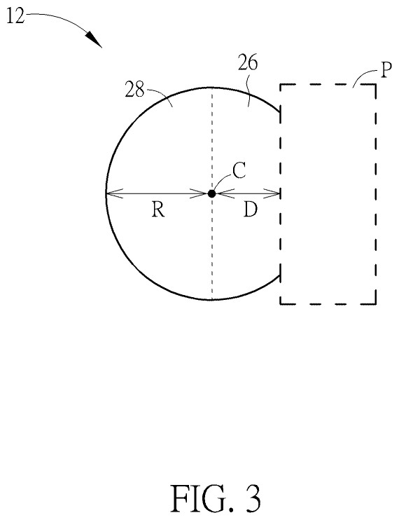

Please refer to FIGS. 2 and 3. FIG. 2 is a side view of a beam projection apparatus 10 according to an embodiment of the present invention, and FIG. 3 is a top view of a condensing lens 12 in FIG. 2. The beam projection apparatus 10 could be preferably applied to vehicle lighting for projecting illumination beams as headlights or to projection imaging for providing projection beams as a projector (but not limited thereto). As shown in FIG. 2, the beam projection apparatus 10 includes at least one condensing lens 12 (two shown in FIG. 2, but not limited thereto), at least one light source 14 (one shown in FIG. 2, but not limited thereto), a reflective-transmissive component 16, a wavelength-conversion component 18, a micromirror component 20, a light-guide lens set 22, and at least one projection lens 24 (six shown in FIG. 2, but not limited thereto).

The condensing lens 12 could be preferably a collimator lens (but not limited thereto) and includes a first lens portion 26 and a second lens portion 28 for collimating a color light L emitted by the light source 14. The reflective-transmissive component 16 is partially overlapped with the first lens portion 26 and has a dichroic region 30 and a reflective region 32. The dichroic region 30 could be a dichroic filter that only allows the color light L to pass therethrough to be incident on the first lens portion 26. The reflective region 32 is located on at least one side of the dichroic region 30 (e.g., on two sides of the dichroic region 30 as shown in FIG. 2, but not limited thereto) to reflect the color light L reflected from the wavelength-conversion component 18, for making the color light L pass through the first lens portion 26 again to be incident to the wavelength-conversion component 18, thus preventing scattering and light leakage caused by the color light L reflected back to the reflective-transmissive component 16. The wavelength-conversion component 18 is located on a side of the condensing lens 12 to at least partially convert the wavelength of the color light L and reflect the color light L back to the condensing lens 12, so that the color light L can travel along a light-exit axis o of the second lens portion 28. Furthermore, as shown in FIGS. 2 and 3, in this embodiment, a distance D between a blocking projection P of the reflective-transmissive component 16 on the first lens portion 26 and a central axis C of the condensing lens 12 could be preferably less than or equal to three-quarters of a radius R of the condensing lens 12, but the present invention is not limited thereto, meaning that a blocking position of the reflective-transmissive component 16 may vary according to the actual light-blocking requirements of the beam projection apparatus 10. In addition, the beam projection apparatus 10 could further include a reflective sheet 34 disposed corresponding to the dichroic region 30 to more accurately reflect the color light L emitted from the light source 14 to the dichroic region 30, thereby improving the light utilization efficiency of the beam projection apparatus 10.

To be more specific, in this embodiment, the wavelength-conversion component 18 could include at least one fluorescent layer 17 (one shown in FIG. 2, but not limited thereto), so that the color light L can be incident on the fluorescent layer 17 and be excited to produce a wavelength-conversion phenomenon. For example, the light source 14 could preferably be a laser or LED light source emitting a blue light, and the fluorescent layer 17 could be a yellow phosphor layer. Accordingly, the fluorescent layer 17 can convert the color light L into a yellow light, and then the yellow light can be mixed with the reflected color light L to form a white light. Alternatively, the fluorescent layer 17 could be a red-green phosphor layer, which can convert the color light L into a red light and a green light, and then the red light and the green light can be mixed with the reflected color light L to form a white light. However, the types of color light and phosphor layers can vary according to the actual optical projection requirements of the beam projection apparatus 10. To be noted, in this embodiment, the wavelength-conversion component 18 could be movable on the side of the condensing lens 12 to enhance the color light excitation effect and prevent overheating of the wavelength-conversion component 18. For example, as shown in FIG. 2, the wavelength-conversion component 18 could move reciprocally relative to the condensing lens 12 (e.g., moving left and right along a direction perpendicular to the central axis C in FIG. 2, but not limited thereto). In another embodiment, the wavelength-conversion component 18 could be a phosphor wheel to rotate relative to the condensing lens 12.

Furthermore, as shown in FIG. 2, the micromirror component 20 is disposed on another side of the condensing lens 12 relative to the wavelength-conversion component 18. The light-guide lens set 22 is disposed on the light-exit axis O to guide the color light L to the micromirror component 20 for forming a projection beam B, and then the projection lens 24 can receive the projection beam B for optical projection. To be more specific, in this embodiment, the micromirror component 20 could be preferably a digital micromirror device, the light source 14 and the micromirror component 20 are disposed on two sides of the light-exit axis O, and the light-guide lens set 22 could include a reflective concave mirror 30 disposed on the light-exit axis O. As such, the reflective concave mirror 30 can reflect the wavelength-converted light traveling along the light-exit axis O of the second lens portion 28 to the micromirror component 20, and then the micromirror component 20 reflects the received light to form the projection beam B, so as to make the projection beam B pass through the projection lens 24, thereby allowing the beam projection apparatus 10 to provide a multicolor laser beam necessary for subsequent optical projection.

In summary, compared with the prior art directly utilizing a light blocking sheet to block light leakage paths, the present invention adopts the design in which the reflective-transmissive sheet is partially overlapped with the condensing lens, thereby allowing the color light emitted from the light source to pass through the dichroic region to be incident to the condensing lens and utilizing the reflective region to block the color light reflected back to the reflective-transmissive sheet. In such a manner, the present invention can effectively solved the light leakage problem caused by stray light reflections mentioned in the prior art, so as to significantly improve the image projection or lighting quality of the beam projection apparatus and effectively enhance the light utilization efficiency of the beam projection apparatus.

In practical applications, the beam projection apparatus 10 could include a diffuser, a light homogenizing component (preferably a lens array, but not limited thereto), or a light adjusting component (e.g., a reflective mirror or a convex/concave lens) disposed between the light source 14 and the wavelength-conversion component 18. Accordingly, the diffuser could further diffuse and homogenize the energy and directionality of the color light L. The light homogenizing component could receive the color light L from the light source 14 to perform color light mixing, thereby producing light splitting, beam shaping, and light spot merging effects. The light adjusting component could be used to focus or diverge the color light L, change a beam size of the color light L, or alter a traveling direction of the color light L. As for which configuration (or any combination) is adopted, it depends on the actual optical projection requirements of the beam projection apparatus 10. In addition, the beam projection apparatus 10 could include a heat dissipation substrate 38 (simply represented by a dashed box in FIG. 2), which can simultaneously hold the condensing lens 12 and the wavelength-conversion component 18. The aforesaid design not only improves the internal heat dissipation efficiency of the beam projection apparatus 10, but also achieves modular heat dissipation, thereby further reducing space occupied by internal components of the beam projection apparatus 10 to be advantageous to the thinning design of the beam projection apparatus 10.

Furthermore, the beam projection apparatus 10 could include another light source disposed on another side of the wavelength-conversion component 18 relative to the condensing lens 12, for emitting another color light (e.g., a blue light, but not limited thereto) to the wavelength-conversion component 18. As such, the aforesaid color light could be at least partially wavelength-converted, so as to further improve the projection brightness of the beam projection apparatus 10.

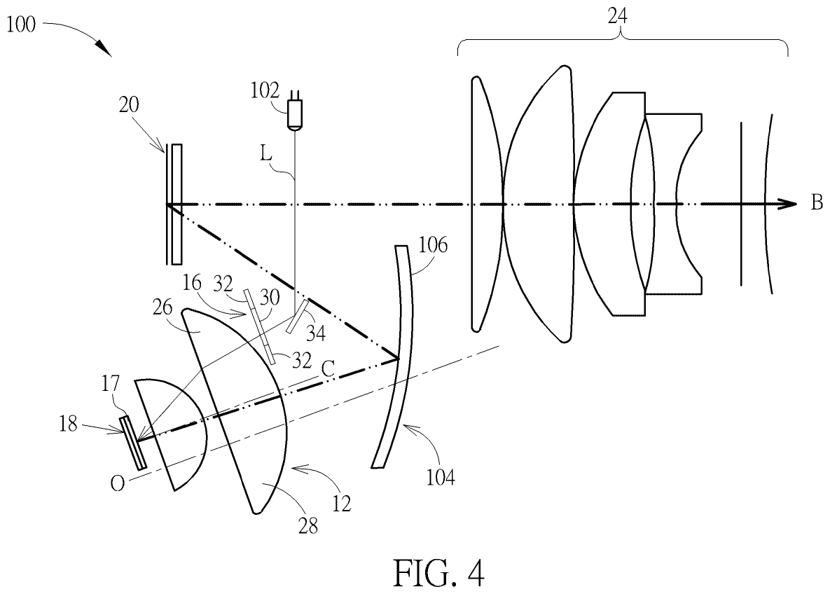

It should be mentioned that, in addition to the aforementioned design of disposing the light source and the micromirror component on opposite sides of the light-exit axis of the condensing lens, the present invention could also adopt a design in which the light source and the micromirror component are disposed on the same side of the light-exit axis. For example, please refer to FIG. 4, which is a side view of a beam projection apparatus 100 according to another embodiment of the present invention. Components both mentioned in this embodiment and the aforesaid embodiments represent components with similar structures or functions, and the related description is omitted herein. As shown in FIG. 4, the beam projection apparatus 100 includes the condensing lens 12, at least one light source 102 (one shown in FIG. 4, but not limited thereto), the reflective-transmissive component 16, the wavelength-conversion component 18, the micromirror component 20, a light-guide lens set 104, and the projection lens 24. In this embodiment, the light-guide lens set 104 includes a reflective concave mirror 106, the light source 102 and the micromirror component 20 are located on the same side of the light-exit axis O, and the reflective concave mirror 106 is disposed on the light-exit axis O. Accordingly, the color light L emitted by the light source 102 can pass through the dichroic region 30 and the first lens portion 26 sequentially to be incident to the wavelength-conversion component 18 for at least partial wavelength conversion, and then be reflected by the wavelength-conversion component 18 to the condensing lens 12. Subsequently, the color light L travels along the light-exit axis O of the second lens portion 28 and is reflected by the reflective concave mirror 106 to the micromirror component 20 for forming the projection beam B. At the same time, the projection lens 24 receives the projection beam B for optical projection. As for the other related description for the beam projection apparatus 100 (e.g., the aforesaid designs of the diffuser, the light homogenizing component, the light adjusting component, the heat dissipation substrate and another light source), it could be reasoned by analogy according to the aforesaid embodiments and omitted herein.

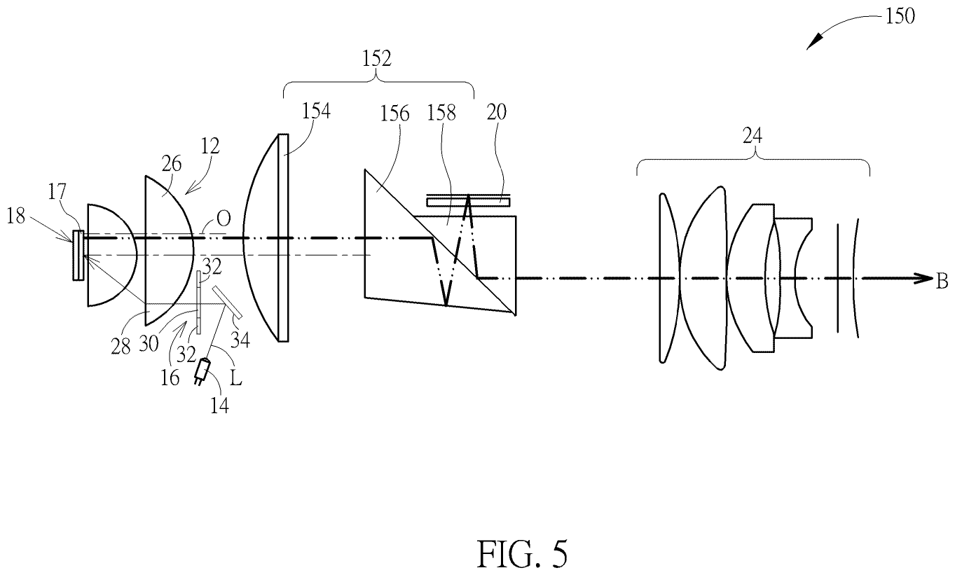

Furthermore, the present invention could also adopt a dual-prism configuration. For example, please refer to FIG. 5, which is a side view of a beam projection apparatus 150 according to another embodiment of the present invention. Components both mentioned in this embodiment and the aforesaid embodiments represent components with similar structures or functions, and the related description is omitted herein. As shown in FIG. 5, the beam projection apparatus 150 includes the condensing lens 12, the light source 14, the reflective-transmissive component 16, the wavelength-conversion component 18, the micromirror component 20, a light-guide lens set 152, and the projection lens 24. In this embodiment, the light guide lens set 152 includes at least one illumination lens 154 (one shown in FIG. 5, but not limited thereto), a first triangular prism 156, and a second triangular prism 158. The illumination lens 154 is disposed on the light-exit axis O between the condensing lens 12 and the first triangular prism 156. The first triangular prism 156 is disposed on the light-exit axis O to reflect the color light L from the illumination lens 154 to the second triangular prism 158. The second triangular prism 158 is opposite to the first triangular prism 156 on the light-exit axis O and allows the color light L reflected by the first triangular prism 156 to pass therethrough to be incident to the micromirror component 20, and the projection beam B returned by the micromirror component 20 is then reflected to the projection lens 24 by the second triangular prism 158. As such, the projection lens 24 can receive the projection beam B from the light-guide lens set 152 for optical projection. As for the other related description for the beam projection apparatus 150 (e.g., the aforesaid designs of the diffuser, the light homogenizing component, the light adjusting component, the heat dissipation substrate and another light source), it could be reasoned by analogy according to the aforesaid embodiments and omitted herein.

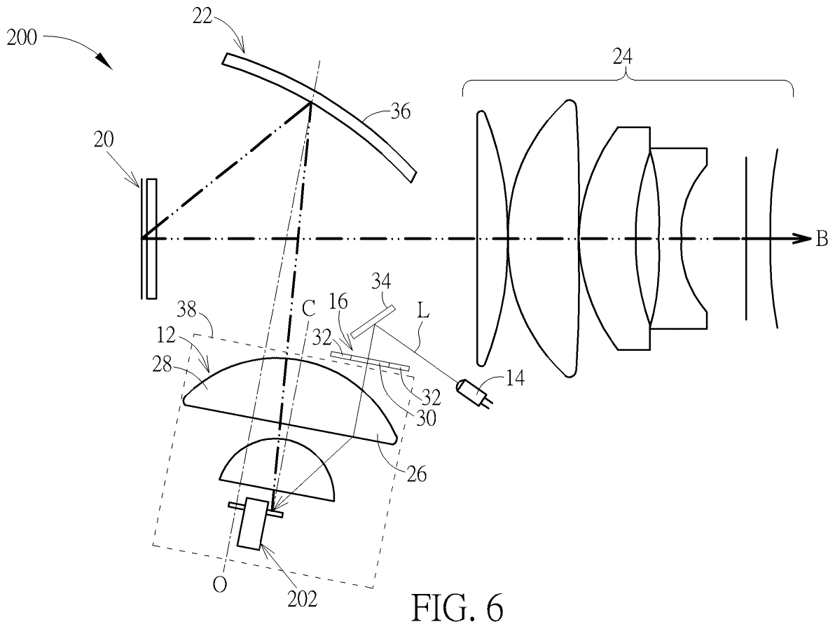

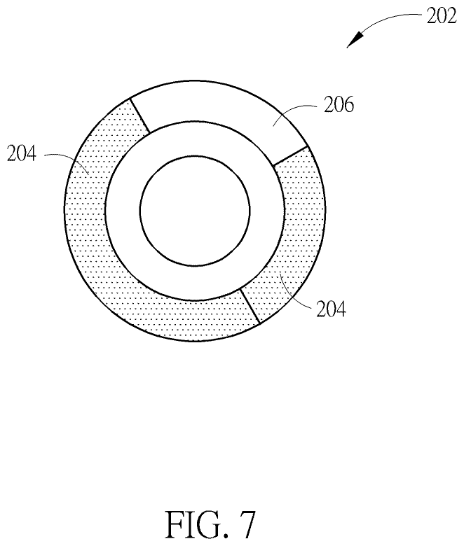

Moreover, in addition to the single fluorescent layer design, the present invention could adopt a rotatable fluorescent color wheel design. For example, please refer to FIGS. 6 and 7. FIG. 6 is a side view of a beam projection apparatus 200 according to another embodiment of the present invention. FIG. 7 is an enlarged diagram of a color wheel of a wavelength-conversion component 202 in FIG. 6. Components both mentioned in this embodiment and the aforesaid embodiments represent components with similar structures or functions, and the related description is omitted herein. As shown in FIGS. 6 and 7, the beam projection apparatus 200 includes the condensing lens 12, the light source 14, the reflective-transmissive component 16, the wavelength-conversion component 202, the micromirror component 20, the light-guide lens set 22, and the projection lens 24. In this embodiment, the wavelength-conversion component 202 is a rotatable fluorescent color wheel and includes at least one fluorescent layer 204 (preferably red/green fluorescent layers shown in FIG. 7, but not limited thereto) and is rotatably disposed on one side of the condensing lens 12. Furthermore, the wavelength-conversion component 202 could also include a reflective layer 206, and the color light L can be incident on the reflective layer 206 and then reflected to the condensing lens 12. During the rotation of the fluorescent color wheel, the color light L emitted by the light source 14 is incident to the fluorescent layer 204 to be converted into a red light and a green light, and the color light L is reflected to the condensing lens 12 by the reflective layer 206 without wavelength conversion. As such, the red light and the green light excited by the fluorescent layer 204 can be mixed with the reflected color light to form a white light for subsequent optical projection. As for the other related description for the beam projection apparatus 200 (e.g., the aforesaid designs of the diffuser, the light homogenizing component, the light adjusting component, the heat dissipation substrate and another light source), it could be reasoned by analogy according to the aforesaid embodiments and omitted herein.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A beam projection apparatus comprising:
at least one light source emitting a color light;
at least one condensing lens having a first lens portion and a second lens portion;
a wavelength-conversion component disposed on a side of the at least one condensing lens for at least partially converting a wavelength of the color light transmitted from the first lens portion and reflecting the color light to the at least one condensing lens, to make the color light travel along a light-exit axis of the second lens portion;
a reflective-transmissive component partially overlapped with the first lens portion and having a dichroic region and a reflective region, the dichroic region allowing the color light to pass therethrough to be incident to the first lens portion, and the reflective region being located on at least side of the dichroic region to reflect the color light reflected from the wavelength-conversion component, for making the color light pass through the first lens portion again to be incident to the wavelength-conversion component;
a micromirror component disposed on another side of the at least one condensing lens relative to the wavelength-conversion component;
a light-guide lens set disposed on the light-exit axis to guide the color light to be incident to the micromirror component for forming a projection beam; and
at least one projection lens receiving the projection beam for optical projection.

2. The beam projection apparatus of claim 1, wherein a distance between a blocking projection of the reflective-transmissive component on the first lens portion and a central axis of the at least one condensing lens is less than or equal to three-quarters of a radius of the at least one condensing lens.

3. The beam projection apparatus of claim 1, wherein the beam projection apparatus further comprises a reflective sheet disposed corresponding to the dichroic region, for reflecting the color light emitted from the at least one light source to the dichroic region.

4. The beam projection apparatus of claim 1, wherein the at least one light source and the micromirror component are disposed on two sides of the light-exit axis, and the light-guide lens set comprises a reflective concave mirror disposed on the light-exit axis to guide the color light to the micromirror component.

5. The beam projection apparatus of claim 1, wherein the light source and the micromirror component are disposed on the same side of the light-exit axis, and the light-guide lens set comprises a reflective concave mirror disposed on the light-exit axis to guide the color light to the micromirror component.

6. The beam projection apparatus of claim 1, wherein the light-guide lens set comprises at least one illumination lens, a first triangular prism, and a second triangular prism, the at least one illumination lens is disposed on the light-exit axis and located between the at least one condensing lens and the first triangular prism, the first triangular prism is disposed on the light-exit axis to reflect the color light from the at least one illumination lens to the second triangular prism, and the second triangular prism is opposite to the first triangular prism and disposed on the light-exit axis for allowing the color light reflected by the first triangular prism to pass therethrough to be incident to the micromirror component and reflecting the projection beam returned by the micromirror component to the at least one projection lens.

7. The beam projection apparatus of claim 1, wherein the beam projection apparatus further comprises a diffuser disposed on the dichroic region.

8. The beam projection apparatus of claim 1, wherein the beam projection apparatus further comprises a light homogenizing component disposed on the dichroic region.

9. The beam projection apparatus of claim 8, wherein the light homogenizing component is a lens array.

10. The beam projection apparatus of claim 1, wherein the beam projection apparatus further comprises a light adjusting component disposed between the wavelength-conversion component and the at least one light source for focusing the color light, diverging the color light, changing a beam size of the color light, or altering a traveling direction of the color light.

11. The beam projection apparatus of claim 1, wherein the beam projection apparatus further comprises a heat dissipation substrate holding the at least one condensing lens and the wavelength-conversion component.

12. The beam projection apparatus of claim 1, wherein the wavelength-conversion component comprises at least one fluorescent layer, and the color light is incident on the at least one fluorescent layer for wavelength conversion.

13. The beam projection apparatus of claim 12, wherein the wavelength-conversion component is a fluorescent color wheel, and the fluorescent color wheel comprises the at least one fluorescent layer and is rotatably disposed on the side of the at least one condensing lens.

14. The beam projection apparatus of claim 13, wherein the fluorescent color wheel further comprises a reflective layer, and the color light is incident on the reflective layer to be reflected to the at least one condensing lens.

15. The beam projection apparatus of claim 12, wherein the at least one condensing lens is a collimator lens, the at least one light source is a laser source or an LED light source, the at least one fluorescent layer is a yellow phosphor layer, the color light is a blue light, the at least one fluorescent layer converts the color light into a yellow light, and the yellow light is mixed with the color light to form a white light.

16. The beam projection apparatus of claim 12, wherein the at least one condensing lens is a collimator lens, the at least one light source is a laser source or an LED light source, and the at least one fluorescent layer is a red-green phosphor layer, the color light is a blue light, the at least one fluorescent layer converts the color light into a red light and a green light, and the red light and the green light are mixed with the color light to form a white light.

17. The beam projection apparatus of claim 1, wherein the beam projection apparatus further comprises another light source disposed on another side of the wavelength-conversion component relative to the at least one condensing lens, for emitting another color light to the wavelength-conversion component for at least partially converting a wavelength of the another color light.

18. A projector comprising:
at least one light source emitting a color light;
at least one condensing lens having a first lens portion and a second lens portion;
a wavelength-conversion component disposed on a side of the at least one condensing lens for at least partially converting a wavelength of the color light transmitted from the first lens portion and reflecting the color light to the at least one condensing lens, to make the color light travel along a light-exit axis of the second lens portion;
a reflective-transmissive component partially overlapped with the first lens portion and having a dichroic region and a reflective region, the dichroic region allowing the color light to pass therethrough to be incident to the first lens portion, and the reflective region being located on at least side of the dichroic region to reflect the color light reflected from the wavelength-conversion component, for making the color light pass through the first lens portion again to be incident to the wavelength-conversion component;
a micromirror component disposed on another side of the at least one condensing lens relative to the wavelength-conversion component;
a light-guide lens set disposed on the light-exit axis to guide the color light to be incident to the micromirror component for forming a projection beam; and
at least one projection lens receiving the projection beam for optical projection.
